(19) United States
(12) Patent Application Publication
(10) Pub. No.: US 2015/0188200 A1
(43) Pub. Date: Jul. 2, 2015

(54) BATTERY MODULE

(71) Applicants: UER TECHNOLOGY (SHENZHEN) LIMITED, Shenzhen (CN); UER TECHNOLOGY CORPORATION, Miaoli County (TW)

(72) Inventors: RAY-TANG SUN, Miaoli (TW); TSUNG-HSIEN CHUANG, Miaoli (TW); CHENG-GHI FANG, Miaoli (TW); WEN-HSIEN CHEN, Miaoli (TW)

(21) Appl. No.: 14/573,250

(22) Filed: Dec. 17, 2014

(30) Foreign Application Priority Data
Dec. 31, 2013 (TW) 102149358

(51) Int. Cl. H01M 10/613; H01M 10/656; H01M 10/42; H01M 10/6551; H01M 2/10; H01M 6/50; H01M 10/6552

(52) U.S. Cl. CPC H01M 10/5004; H01M 6/5011; H01M 6/5038; H01M 10/5061; H01M 10/5048; H01M 10/5046; H01M 2/1016; H01M 10/4207

(57) ABSTRACT

A battery module includes a base, a battery assembly supported by the base, and a heat dissipation unit for dissipating heat created by the battery assembly. The heat dissipation unit comprises a cooling box defining an interior space to accommodate a cooling fluid, an inlet to feed the cooling fluid into the interior space, and an outlet to discharge the cooling fluid from the interior space, thereby allowing circulation of the cooling fluid in the cooling box.

### CROSS-REFERENCE TO RELATED APPLICATIONS

This application is related co-pending U.S. patent applications of Attorney Docket No. US54737, US54739, and US54740, each entitled “BATTERY MODULE”, and each invented by Sun et al. These applications have the same assignee as the present application.

The above-identified applications are incorporated herein by reference.

### FIELD

The present disclosure relates to a battery module including a plurality of battery cells.

### BACKGROUND

Heat can be created during use of a battery module comprising a plurality of battery cells. Effective heat dissipation is needed for the battery module.

### BRIEF DESCRIPTION OF THE DRAWINGS

Implementations of the present technology will now be described, by way of example only, with reference to the attached figures.

FIG. 1 is an exploded, isometric view of a battery module according to an exemplary embodiment.

FIG. 2 is a partially exploded, isometric view of the battery module of FIG. 1.

FIG. 3 is an assembled, isometric view of the battery module of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

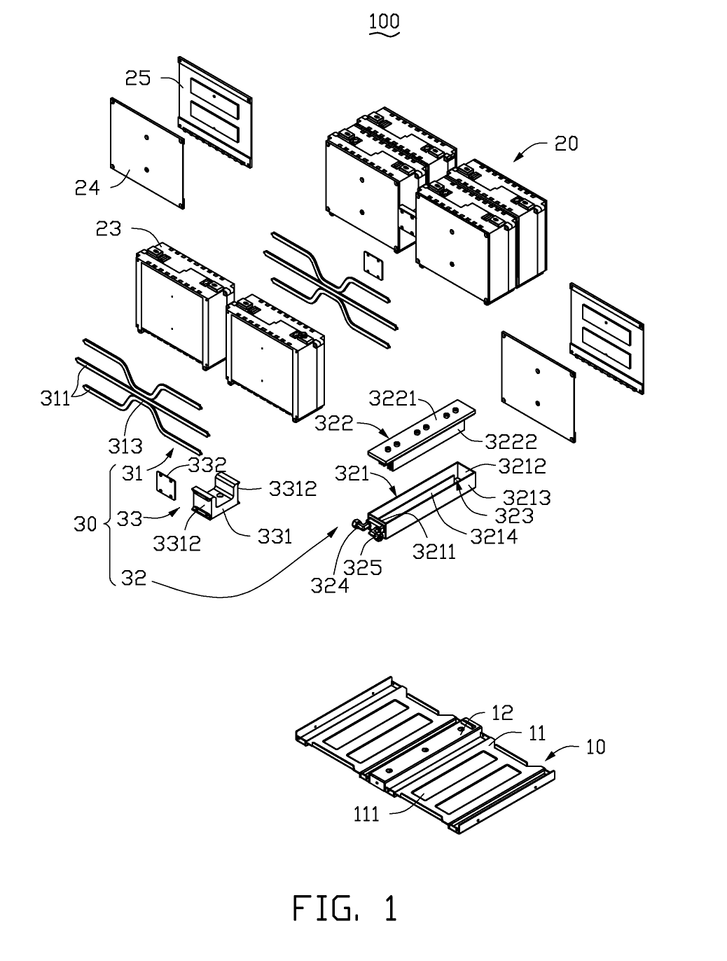

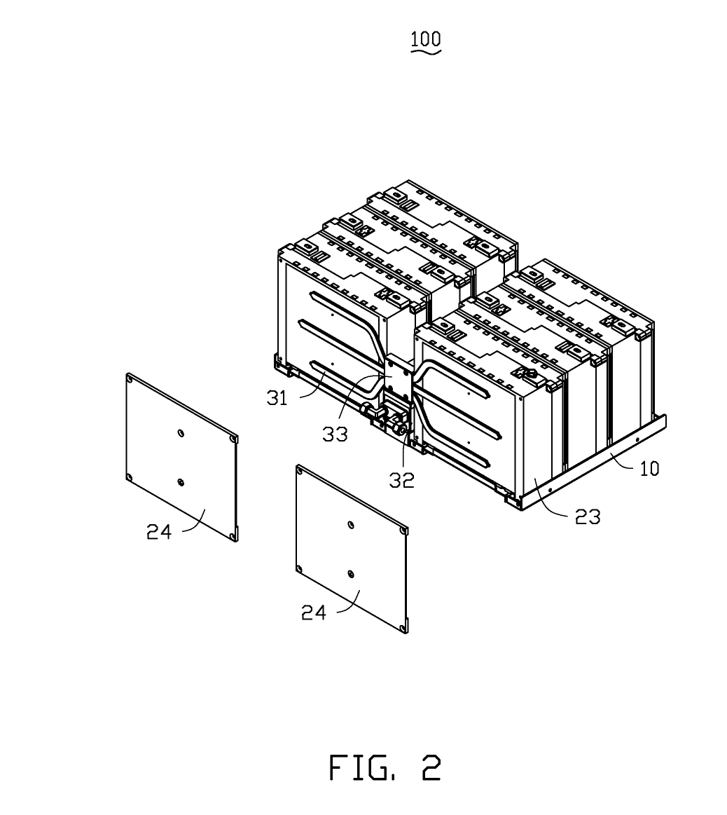

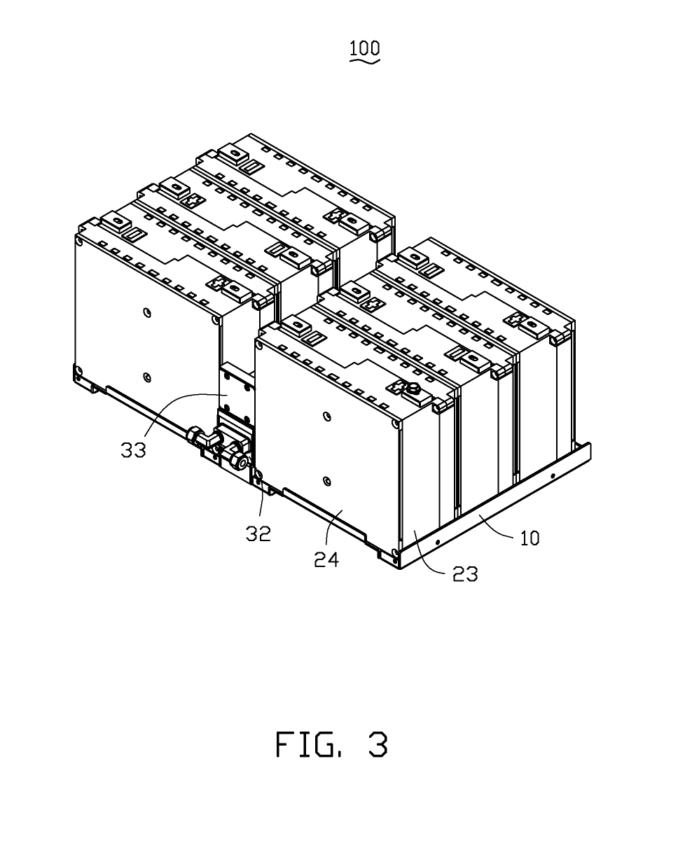

FIG. 1 through FIG. 3 illustrate a battery module 100 comprising a base 10, a battery assembly 20 supported by the base 10, and a heat dissipation unit 30 for dissipating heat created by the battery assembly 20. The heat dissipation unit 30 comprises a cooling box 32. The cooling box 32 defines an interior space 323 to accommodate a cooling fluid, an inlet 324 to feed the cooling fluid into the interior space 323, and an outlet 325 to discharge the cooling fluid from the interior space 323, thereby allowing circulation of the cooling fluid in the cooling box 32.

The base 10 is configured to secure and support the battery assembly 20 and the heat dissipation unit 30. The base 10 comprises a first support portion 11 for supporting the battery assembly 20 and a second support portion 12 for supporting the heat dissipation unit 30. The second support portion 12 is located at a substantially middle portion of the first support portion 11. In at least one embodiment, the second support portion 12 is substantially bar-shaped and protrudes from the first support portion 11.

The battery assembly 20 comprises one or more battery cells 23. In at least one embodiment, the battery assembly 20 comprises a plurality of battery cells 23 arranged in a matrix. In at least one embodiment, the battery cells 23 are arranged in a matrix having two columns and three rows. In other embodiments, the numbers of the rows and the columns can be varied. The battery cells 23 of the same one column are arranged adjacent to another column of battery cells 23. Each of the one of more battery cells 23 can further have a front cover 24 and a back cover 25 covering two opposite side surfaces thereof.

The heat dissipation unit 30 is configured to dissipate heat created by the battery assembly 20. The heat dissipation unit 30 further comprises one or more heat-conducting elements 31 and one or more connecting elements 33. The one or more heat-conducting elements 31 are configured to transmit the heat from the one or more battery cells 23. Each battery cell 23 is in contact with at least one of the one or more connecting elements 33. In the embodiment, each two adjacent rows of the battery cells 23 have one heat-conducting element 31 positioned therebetween and in contact with each battery cell 23 of the two adjacent rows. Each heat-conducting element 31 comprises a plurality of branches 311 extending substantially in a same plane. The branches 311 concentrate at a substantially middle portion to form a fixing portion 313 and extend away from each other at two ends of each branch 311. In at least one embodiment, the branches 311 are heat pipes which are configured to transfer heat between two solid interfaces. The one or more heat-conducting elements 31 are connected to the cooling box 32 through the one or more connecting elements 33.

The cooling box 32 is configured to radiate heat transmitted by the one or more heat-conducting elements 31. In one embodiment, the cooling box 32 comprises a main body 321 defining the interior space 323 and a cover 322. The main body 321 comprises a first end wall 3211, a second end wall 3212 opposite to the first end wall 3211, and two side walls 3213 connected to the first and second end walls 3211, 3212. The first end wall 3211, the second end wall 3212, and the two side walls 3213 surround the interior space 323. The first end wall 3211 defines the inlet 324 and the outlet 325. The inlet 324 and the outlet 325 can be connected to a feeding pipe and a discharging pipe, respectively, to allow a circulation of the cooling fluid in the cooling box 32.

The cooling box 32 can further comprise a baffle 3214 positioned in the interior space 323. The baffle 3214 is connected to a portion of the first end wall 3211 located between the inlet 324 and the outlet 325 and extends towards the second end wall 3211. An end of the baffle 3214 away from the first end wall 3211 is spaced from the second end wall 3211. The baffle 3214 can lengthen a running path of the cooling fluid in the cooling box 32, causing enough contact between the cooling fluid and the cooling box 32 to facilitate removal of heat transmitted by the one or more heat-conducting elements 31, thereby improving heat dissipation efficiency.

The cover 322 covers the main body 321 to close the interior space 323. The cover 322 comprises a cover board 3221 and a plurality of fins 3222 connected to a surface of the cover board 3221 facing the interior space 323. The fins 3222 are substantially parallel to each other and are substantially parallel to the baffle 3214. The fins 3222 extend into the interior space 323 and are located at two sides of the baffle 3214 when the cover 322 covers on the main body 321. The cover board 3221 and the fins 3222 can be made of high heat-conductive material. In at least one embodiment, the cover board 3221 and the fins 3222 are made of the same material and are integrally formed together. The fins 3222 are configured to divide the cooling fluid in the interior space 323 into divisional streams, allowing even heat dissipation of the cooling box 32 and improved the heat dissipation efficiency.

The one or more connecting elements 33 are configured to connect the one or more heat-conducting elements 31 to the cooling box 32. A number of the connecting elements 33 can be equal to a number of the rows of the battery cell matrix. Each connecting element 33 comprises a connecting block 331 and two fastening boards 332. The connecting block 331 defines two locking notches 3312 in two opposite ends. In at least one embodiment, each locking notch 3312 is defined by two flange portions protruding from a top edge and a bottom edge of the connecting block 331 respectively. The two fastening boards 332 are configured to fix the one or more heat-conducting elements 31 to the connecting block 331 by holding the fixing portion 313 in the locking notches 3312.

To assemble the battery module 100, the main body 321 is secured to the second support portion 12. The cover 322 is covered on the main body 321 and the fins 3222 extend into the interior space 323. One connecting block 331 is then secured to a surface of the cover 322 opposite to the fins 3222. A first row of the battery cells 23 is positioned on the first support portion 11 with the battery cells 23 of the first row located at two sides of the connecting block 331. One heat-conducting element 31 is positioned at each side of the first row of the battery cells 23, with the fixing portion 313 of each heat-conducting element 31 locked in the locking notches 3312 by one of the fastening board 332, and the branches 311 of each heat-conducting element 31 are in contact with the two side surfaces of each battery cells 23. The two side surfaces of each battery cells 23 is covered with the front cover 24 and the back cover 25 to cover the branches 311. The other rows of battery cells 23 are assembled by a similar manner.

In use, the inlet 324 is connected to a feeding pipe and the outlet 325 is connected to a discharge pipe. A cooling fluid can be fed into the interior space 323 and flow into the interior space 323. Heat created by the battery cells 23 are conducted by the one or more heat-conducting elements 31 to the one or more connecting elements 33, and then transmitted to the cooling box 32 by the one or more connecting elements 33. The cooling fluid in the cooling box 32 facilitates removal of the heat, thereby dissipating heat created by the battery cells 23.

The embodiments shown and described above are only examples. Many details are often found in the art such as the other features of a battery module. Therefore, many such details are neither shown nor described. Even though numerous characteristics and advantages of the present technology have been set forth in the foregoing description, together with details of the structure and function of the present disclosure, the disclosure is illustrative only, and changes may be made in the details, including in matters of shape, size, and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A battery module comprising:
a base;
a battery assembly supported by the base; and
a heat dissipation unit for dissipating heat created by the battery assembly;
wherein the heat dissipation unit comprises a cooling box defining an interior space configured to accommodate a cooling fluid, an inlet to feed the cooling fluid into the interior space, and an outlet to discharge the cooling fluid from the interior space, thereby allowing circulation of the cooling fluid in the cooling box.

2. The battery module of claim 1, wherein the cooling box comprises a main body and a cover; the interior space is defined in the main body; the cover closes the interior space.

3. The battery module of claim 2, wherein the main body comprises a first end wall, a second end wall opposite to the first end wall, and two side walls connected to the first and second end walls, so that the first end wall, the second end wall, and the two side walls surround the interior space.

4. The battery module of claim 3, wherein the first end wall defines the inlet and the outlet; the cooling box further comprises a baffle positioned in the interior space; the baffle is connected to a portion of the first end wall located between the inlet and the outlet and extends towards the second end wall; and an end of the baffle away from the first end wall is spaced from the second end wall.

5. The battery module of claim 4, wherein the cover comprises:
a cover board; and
a plurality fins connected to a surface of the cover board facing the interior space and extend into the interior space.

6. The battery module of claim 5, wherein the fins are substantially parallel to each other and are substantially parallel to the baffle.

7. The battery module of claim 6, wherein the fins are located at two sides of the baffle.

8. The battery module of claim 1, wherein the heat dissipation unit further comprises:
one or more heat-conducting elements connected to the battery assembly and configured to transmit heat from the battery assembly; and
one or more connecting elements connecting the one or more heat-conducting elements to the cooling box and configured to transmit the heat from the one or more heat-conducting elements to the cooling box.
